(19) United States
(12) Patent Application Publication
(10) Pub. No.: US 2003/0078893 A1
(43) Pub. Date: Apr. 24, 2003

(54) METHOD AND APPARATUS FOR REMOTELY PRINTING POSTAGE INDICIA

(76) Inventors: CHANDRAKANT SHAH, STOCKTON, CA (US); JP LEON, SAN CARLOS, CA (US); DAVID A. COOLIDGE, BERKELEY, CA (US)

Correspondence Address: TRUONG T DINH, TOWNSEND AND TOWNSEND AND CREW LLP, TWO EMBARCADERO CENTER, 8TH FLOOR, SAN FRANCISCO, CA, 941113834

(21) Appl. No.: 09/358,511

(22) Filed: Jul. 21, 1999

Related U.S. Application Data
(63) Continuation of application No. 09/012,037, filed on Jan. 22, 1998, now Pat. No. 6,240,403.
(63) Continuation of application No. 09/122,168, filed on Jul. 24, 1998, now Pat. No. 6,269,350.
(63) Continuation of application No. 09/250,990, filed on Feb. 16, 1999, now Pat. No. 6,424,954.
(60) Provisional application No. 60/093,849, filed on Jul. 22, 1998.
(60) Provisional application No. 60/094,065, filed on Jul. 24, 1998.
(60) Provisional application No. 60/094,073, filed on Jul. 24, 1998.
(60) Provisional application No. 60/094,116, filed on Jul. 24, 1998.
(60) Provisional application No. 60/094,120, filed on Jul. 24, 1998.
(60) Provisional application No. 60/094,122, filed on Jul. 24, 1998.
(60) Provisional application No. 60/094,127, filed on Jul. 24, 1998.

(51) Int. Cl. G06F 17/60

(52) U.S. Cl. 705/60

(57) ABSTRACT

A postage metering system that includes a central processing system and a remote postage printing device (RPPD). The central processing system includes a secure metering device (SMD) operatively coupled to a central computer and configured to store accounting information. The RPPD operatively couples to the SMD via a wireless communications link. The RPPD receives a user request for postage, transmits the user request to the SMD via the wireless communications link, receives a secure postage indicium from the SMD, and directs printing of an indicium. The secure postage indicium can be generated using digital signature, encryption, or encoding, or a combination thereof.

This application claims priority from the following U.S. provisional and non-provisional applications, the disclosures of which, including software appendices and all attached documents, are incorporated by reference in their entirety for all purposes:

Application Serial No. 60/093,849, entitled “Method and Apparatus for Postage Label Authentication,” filed Jul. 22, 1998, of J P Leon and David A. Coolidge;

Application Serial No. 60/094,065, entitled “Method and Apparatus for Resetting Postage Meter,” filed Jul. 24, 1998, of J P Leon;

Application Serial No. 60/094,073, entitled “Method, Apparatus, and Code for Maintaining Secure Postage Information,” filed Jul. 24, 1998, of J P Leon, Albert L. Pion, and Elizabeth A. Simon;

Application Serial No. 60/094,116, entitled “Method and Apparatus for Dockable Secure Metering Device,” filed Jul. 24, 1998, of J P Leon;

Application Serial No. 60/094,120, entitled “Method and Apparatus for Remotely Printing Postage Indicia,” filed Jul. 24, 1998, of Chandrakant J. Shah, J P Leon, and David A. Coolidge;

Application Serial No. 60/094,122, entitled “Postage Metering System Employing Positional Information,” filed Jul. 24, 1998, of J P Leon;

Application Serial No. 60/094,127, entitled “Method and Apparatus for Operating a Removable Secure Metering Device,” filed Jul. 24, 1998, of J P Leon;

Application Ser. No. 09/012,037, entitled “Method and Apparatus for a Modular Postage Accounting System,” filed Jan. 22, 1998, of Chandrakant J. Shah and Keith B. Robertson;

Application Ser. No. 09/122,168, “Method and Apparatus for Placing Automated Service Call for Postage Meter and Base,” filed Jul. 24, 1998, of Chandrakant J. Shah; and

Application Ser. No. 09/250,990, entitled “Postage Meter System,” filed Feb. 16, 1999, of J P Leon.

The following related patent applications filed on the same day herewith are hereby incorporated by reference in their entirety for all purposes:

U.S. patent application Ser. No. (Attorney Docket No. 6969-159.1), entitled “Method and Apparatus for Operating a Secure Metering Device,” of J P Leon;

U.S. patent application Ser. No. (Attorney Docket No. 6969-160.1), entitled “Method and Apparatus for Postage Label Authentication,” of J P Leon;

U.S. patent application Ser. No. (Attorney Docket No. 6969-161.1), entitled “Method, Apparatus, and Code for Maintaining Secure Postage Data,” of J P Leon, Albert L. Pion, and Elizabeth A. Simon;

U.S. patent application Ser. No. (Attorney Docket No. 6969-162.1), entitled “Postage Metering System Employing Positional Information,” of J P Leon; and

U.S. patent application Ser. No. (Attorney Docket No. 6969-163.1), entitled “Method and Apparatus for Resetting Postage Meter,” of J P Leon.

### BACKGROUND OF THE INVENTION

The present invention relates generally to postage metering systems, and more particularly to a postage printing device capable of printing postage indicia and having a wireless communications link to a secure metering device.

Historically, postage meters have been dedicated, stand-alone devices capable only of printing postage indicia on envelopes or labels (in the case of parcels). These meters typically reside at a single user location and provide postage metering for that location alone. Such meters conventionally require the user to physically transport the device to a post office for “resetting” to increase the amount of funds contained in the meter.

An advance over these meters is the ability to allow the user to reset the meter via codes, provided by either the manufacturer or the postal authority, once payment has been made by the user. Modern electronic meters are often capable of being reset directly by an authorized party on-site at the user's location via a communications link. One such system that performs meter resetting in this manner is known as a Computerized Meter Resetting System (CMRS). The party having authority to reset the meter and charge the customer (usually the manufacturer or the postal authority) gains access to and resets the meter.

Even with remote resetting, postage meters are still, for the most part, limited to use at a single physical location. As such devices are typically dedicated and also sophisticated in their fail-safe attributes and security, their price tends to be prohibitive for small entities.

As can be seen, what is needed is a postage metering system that is portable, low-cost, and does not require complex security features. Moreover, a system that centralizes both postage accounting and security functions is also desirable. Preferably, such system would allow printing of postage indicia at locations that are convenient to the user.

### SUMMARY OF THE INVENTION

The invention provides a postage metering system that includes a number of remote postage printing devices (RPPDs) coupled to a central processing system via a wireless communications link. The central processing system includes a secure metering device (SMD) that stores accounting information and provides secure processing. The RPPDs are located at user sites and communicate with the central processing system (or more specifically, the SMD) via the wireless link. The RPPD receives user request to print postage and, when authorized, directs printing of postage indicium. The SMD receives and processes the user request, and authorizes the indicium printing. The RPPD can be designed as a simple, low-cost, portable unit. The SMD provides centralized and secure storage of accounting information.

An embodiment of the invention provides a postage metering system that includes a central processing system and a remote postage printing device (RPPD). The central processing system includes a secure metering device (SMD) operatively coupled to a central computer and configured to store accounting information. The RPPD operatively couples to the SMD via a wireless communications link. The RPPD receives a user request for postage, transmits the user request to the SMD via the wireless communications link, receives a secure postage indicium from the SMD, and directs printing of an indicium. The secure postage indicium can be generated using digital signature, encryption, or encoding, or a combination thereof.

In an embodiment, the RPPD includes a processor, a print unit, a wireless communications device, and a housing that encloses these units. Communication over the wireless link can be achieved through first and second wireless communications devices located within the central computer and the RPPD, respectively.

Another embodiment of the invention provides a method for remotely printing postage. In accordance with the method, a user request for postage is received at a remote postage printing device (RPPD) and sent to a central secure metering device (CSMD) via a wireless communications link. The CSMD can authenticate the user request from the RPPD (e.g., using digital signature) to verify its legitimacy. A secure postage indicium is generated in response to the (authenticated) user request and sent to the RPPD. The RPPD verifies the authenticity of the secure postage indicium and directs printing of a postage indicium in accordance with the verified secure postage indicium.

The invention also provides computer-implemented program products that implement the method described above.

The foregoing, together with other aspects of this invention, will become more apparent when referring to the following specification, claims, and accompanying drawings.

### BRIEF DESCRIPTION OF THE DRAWINGS

FIGS. 1 through 3 show diagrams of three embodiments of a postal system in accordance with the invention;

FIG. 4 shows a block diagram of an embodiment of a generic computer that can be used to implement the computers in the postal systems in FIGS. 1 through 3;

FIG. 5 shows a simplified block diagram of an embodiment of a SMD that can implement the SMDs in the postal systems in FIGS. 1 through 3;

FIG. 6 shows a flow diagram of an embodiment of a process for generating and remotely printing postage indicia in accordance with the invention; and

FIG. 7 shows an illustration of a specific embodiment of an indicium generated and remotely printed in accordance with the invention.

### DESCRIPTION OF THE SPECIFIC EMBODIMENTS

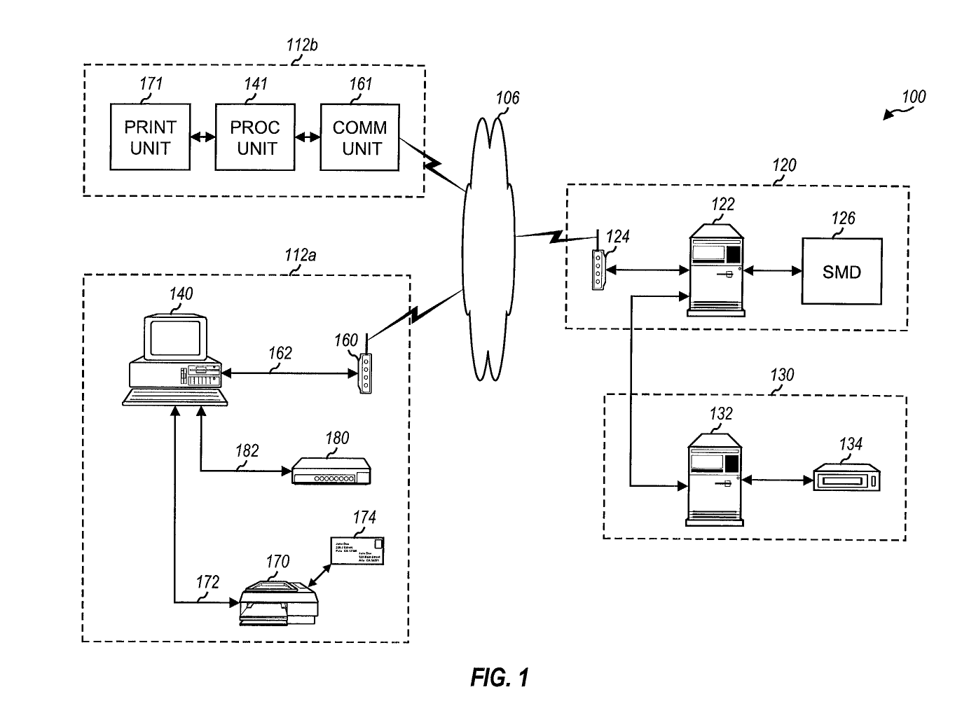

FIG. 1 shows a diagram of an embodiment of a postal system 100 in accordance with the invention. Postal system 100 includes remote postage printing devices (RPPDs) 112a and 112b, a central processing system 120, and an (optional) postal information system 130. RPPDs 112 and central processing system 120 communicate via a wireless communications link 106 that can be a cellular, terrestrial, satellite, RF, infrared, microwave, or other links.

Central processing system 120 includes a central computer 122 coupled to a wireless communications device 124 and a secure metering device (SMD) 126. The combination of SMD 126 with central computer 122 forms a central SMD (CSMD) that facilitates and enables remote printing of postage over a wireless link. Many aspects of central processing system 120 are subject of government standards and are not described in detail herein. The interaction between central processing system 120 and RPPDs 112 is discussed below, as necessary for the understanding of the invention.

Postal information system 130 is a commercially available system, with approximately 150 or more installations in the United States, that provides access to national (and possibly international) postal information such as ZIP codes, rate tables, and other information. Postal information system 130 includes a system server 132 that couples to a storage unit 134 and central processing system 120. Storage unit 134 stores a database of postal information, such as national and international postal ZIP code information and so on. Storage unit 134 can be implemented with a CD-ROM device, a tape drive, a hard disk, other mass storage devices, or a combination of these devices. Various systems, including RPPDs 112, can obtain information from postal information system 130 via central processing system 120. The operation of postal information system 130 is well known in the art and not described in detail herein.

RPPDs 112 perform the postage printing functions associated with conventional postage meters, and each RPPD can be designed as a stationary system, a portable system, or even a hand-held system. As shown in FIG. 1, stationary RPPD 112a includes a general-purpose computer 140 that couples to a wireless communications device 160, a printer 170, and an (optional) electronic scale 180 via communications links 162, 172, and 182, respectively. Each of these links can be a wireless link or a wireline link such as a standard serial or parallel interface. Each link may employ any mechanism for transferring data, such as a RS-232C serial communications link.

As shown in FIG. 1, portable RPPD 112b includes a processing (PROC) unit 141 that couples to a wireless communications (COMM) unit 161 and a print unit 171. Although not shown in FIG. 1, RPPD 112b includes a user interface unit coupled to processing unit 141. RPPD 112b is typically enclosed in a housing for convenient handling and ease of relocation. RPPD 112b can also be designed as a hand-held unit.

Computer 140 and processing unit 141 are the processors for RPPDs 112a and 112b, respectively. Each processor directs operations of the units to which it couples, such as the print, communications, and interface units. Each processor further performs the necessary processing (e.g., encryption/decryption, encoding/decoding, digital signature generation/authentication, and so on) of incoming and outgoing messages. For example, the processor can receive a message that includes a secure postage indicium, process the message, and direct the print unit to print the indicium onto a mailpiece or a label. For simplicity, computer 140 and processing unit 141 are generically herein referred to as the “remote computer.”

Printer 170a and print unit 170b can each be a laser printer, a printer specially designed for printing postage indicia, or other printing mechanisms. The printer prints postage indicia on labels, envelopes, or other media, as exemplified by a mail piece 174 in FIG. 1.

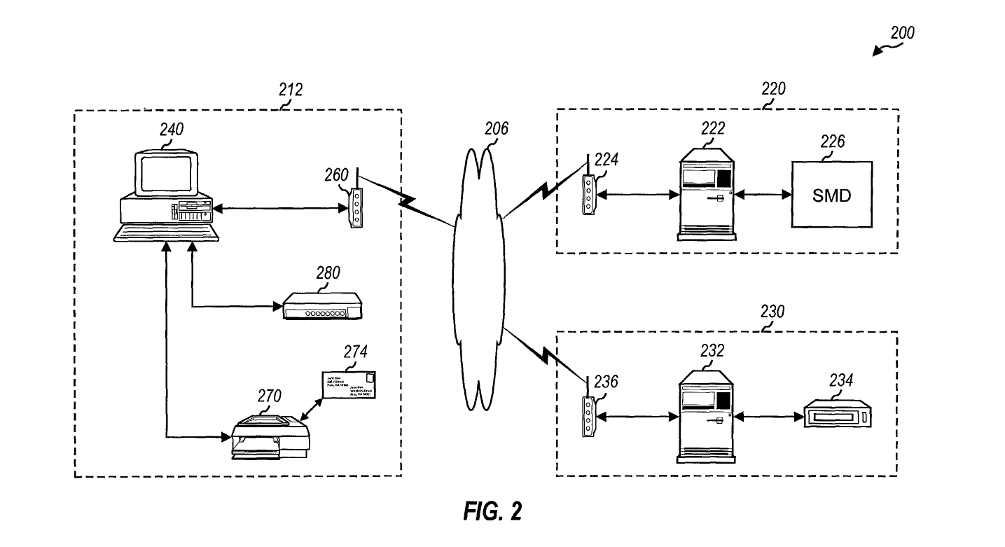

FIG. 2 shows a diagram of another embodiment of a postal system 200 in accordance with the invention. Postal system 200 includes a remote postage printing device (RPPD) 212, a central processing system 220, and an (optional) postal information system 230, all communicating via a wireless communications link 206. Postal system 200 operates in similar manner as that of postal system 100, but supports a Centralized Meter Resetting System (CMRS) currently in use by the United States Postal Service (USPS) and other qualified vendors. Central processing system 220 and postal information system 230 operate in similar manner as systems 120 and 130, respectively, in FIG. 1.

As shown in FIG. 2, a central computer 222 couples to a SMD 226 to form a CSMD. A user desiring to print postage enters a postage request into a remote computer 240 of RPPD 212. Remote computer 240 then communicates the user request to central computer 222 via wireless communications link 206. The communication is performed by communications devices 224 and 260 coupled to computers 222 and 240, respectively. Central computer 222 receives and forwards the user request to SMD 226.

SMD 226 receives and processes the user request. SMD 226 then responds to the request by sending a secure (e.g., encrypted, encoded, or signed) postage indicia file and additional information (e.g., an unique identification number generated for the transaction) to remote computer 240 via link 206. Computer 240 receives the transmission from SMD 226 and constructs a postage indicia print file. The print file and other optional data (such as address information, ZIP-code bar coding, and other user-defined information) are provided to a printer 270 for printing.

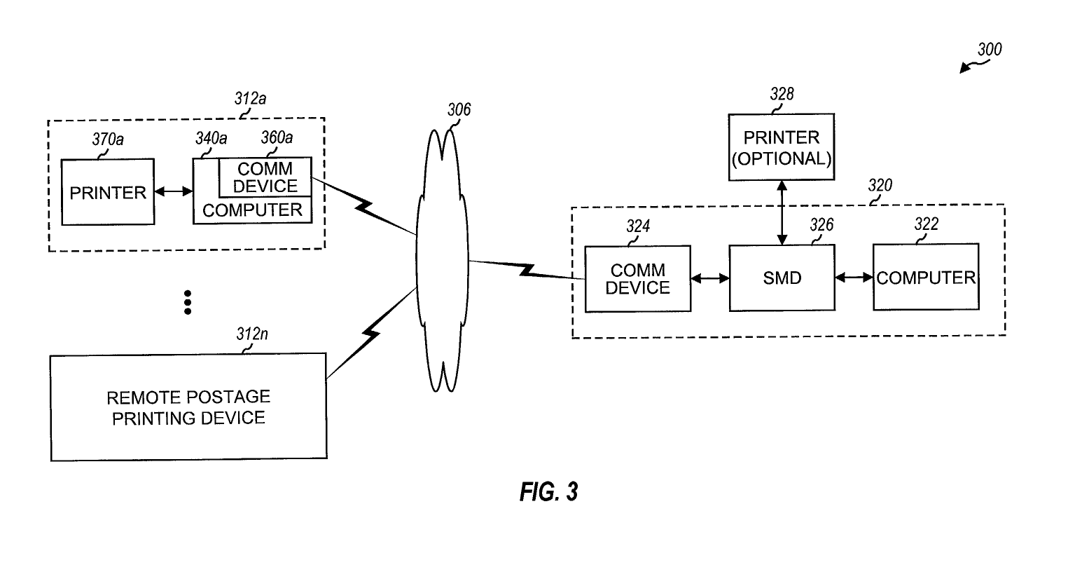

FIG. 3 shows a diagram of yet another embodiment of a postal system 300 in accordance with the invention. A CSMD 320 communicates with a number of RPPDs 312a through 312n via a wireless communications link 306. As shown in FIG. 3, CSMD 320 comprises a SMD 326 coupled to a central computer 322 and a wireless communications device 324. An (optional) printer 328 can be coupled to SMD 326 (as shown in FIG. 3) or to central computer 322. In an alternative configuration, wireless communications device 324 may be coupled to central computer 322, in which case SMD 326 communicates with RPPDs 312 via central computer 322 and its wireless communications device. Other configurations will be apparent to one skilled in the art and are within the scope of the invention.

As shown in FIG. 3, each RPPD 312 includes a remote computer 340 coupled to a printer 370. Remote computer 340 includes or couples to a wireless communications (COMM) device 360 that facilitates communication between RPPD 312 and CSMD 320 via wireless link 306.

In FIGS. 1 through 3, the SMD may be coupled to the central computer in various configurations. In one configuration, the SMD is housed separately from the central computer and the link between these units can be a wireline or wireless link, and is preferably a secure link. The secure link can be achieved by any mechanism designed to transfer data in a manner that is impervious to unauthorized interception. Such secure link can be implemented, for example, by sending encrypted, encoded, or signed data over a RS-232C serial communications line. In another configuration, the SMD is housed within the central computer and communicates directly with the cental computer via the computer's system bus. The secure link may thus be achieved by embedding the SMD within the central computer. The SMD is preferably enclosed in a tamper-evident and/or tamper-resistant housing to deter tampering by unauthorized persons.

In accordance with an aspect of the invention, one or more SMDs may be coupled to, or embedded within, the central computer. Moreover, a single SMD can be configured to service one or more central computers. Multiple SMDs may be placed at one or more sites that may be geographically separated. Each SMD module performs the data storage and accounting functions of a conventional postage meter.

The SMDs may be organized in various configurations. For example, a particular user may have postage data maintained in a single SMD or multiple SMDs. Further, a particular SMD may be dedicated to a single user or configured to serve a group of users. The size of the group can vary and may include, for example, users from a single department, multiple departments, or an entire company. The users may be widely dispersed geographically. Generally, the SMD contains postage accounting information for the user(s) it serves, and the information can be partitioned into, or represented by one or more accounts.

In FIGS. 1 through 3, the wireless link may be implemented using any wireless transmission medium such as a cellular, terrestrial, satellite, RF, infrared, or microwave link, or other links. For example, the wireless link may be implemented using a cellular telephone or radio service, a satellite service, a wireless local area network (LAN), or others.

The wireless link may be used to provide one-way or two-way communication. The wireless link facilitates the transmissions of secure (e.g., encrypted, encoded, or signed) postage indicia from the CSMD to the RPPDs. A two-way wireless link can also support transmissions from the RPPDs to the CSMD, which can be used for transmission of: (1) request of specific postage amounts, (2) acknowledgment of receipt of secure postage indicia, (3) return of information regarding RPPD status, and other functionality. The wireless communication allows the transfer of secure postage indicia on an as-needed basis over the wireless medium to the RPPDs.

The wireless communications devices can be implemented by numerous designs. For example, these devices can be modems or transceivers operated at various frequency bands (e.g., cellular, RF, microwave, and other bands). The communications devices facilitate and enable communication between the RPPDs and CSMD over the wireless link.

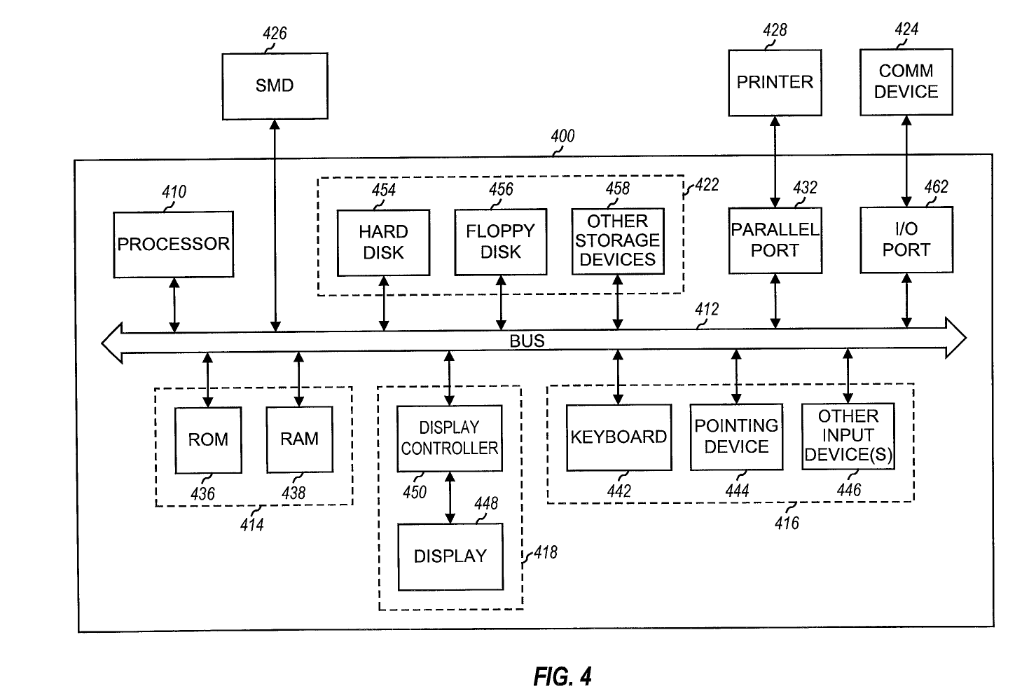

FIG. 4 shows a block diagram of an embodiment of a generic computer 400 that can be used to implement the computers in FIGS. 1 through 3. Computer 400 may be a desktop general-purpose computer system, a portable system, a simplified computer system designed for the specific application described herein, a server, a workstation, a mini-computer, a larger mainframe system, or other computing systems.

As shown in FIG. 4, computer 400 includes a processor 410 that communicates with a number of peripheral devices via a bus 412. These peripheral devices typically include a memory subsystem 414, a user input subsystem 416, a display subsystem 418, a file storage system 422, and output devices such as a printer 428. Memory subsystem 414 may include a number of memory units, including a non-volatile memory 436 (designated as a ROM) and a volatile memory 438 (designated as a RAM) in which instructions and data may be stored. User input subsystem 416 typically includes a keyboard 442 and may further include a pointing device 444 (e.g., a mouse, trackball, or the like) and/or other common input device(s) 446. Display subsystem 418 typically includes a display device 448 (e.g., a cathode ray tube (CRT), a liquid crystal display (LCD), or other devices) coupled to a display controller 450. File storage system 422 may include a hard disk 454, a floppy disk 456, other storage devices 458 (such as a CD-ROM drive, a tape drive, or others), or a combination thereof.

Computer 400 includes a number of I/O devices that facilitate communication with external devices. For example, a parallel port 432 interfaces with printer 428. Communications with external systems can be established via a wireless communications (COMM) device 424 that couples to an I/O port 462. Other interfaces (e.g., for infrared and wireline devices) can also be provided for computer 400. A SMD 426 can couple directly to bus 412, as shown in FIG. 4, or via an interface device.

Each computer in FIGS. 1 through 3 can be implemented with a subset of the elements shown for computer 400, and can also include additional elements not shown in FIG. 4. For example, parallel port 432 and I/O port 462 may not be required if the printer and communications device are coupled directly to bus 412. Further, user input subsystem 416, display subsystem 418, and file storage system 422 can be simplified or may not be required. For example, since processing unit 141 in FIG. 1 is designed for a specific application, it can be implemented with a greatly simplified version of computer 400.

As used herein, the term “bus” generically refers to any mechanism for allowing various elements of the system to communicate with each other. Bus 412 is shown as a single bus but may include a number of buses. For example, a system typically has a number of buses including a local bus and one or more expansion buses (e.g., ADB, SCSI, ISA, EISA, MCA, NuBus, or PCI), as well as serial and parallel ports.

With the exception of the input devices and the display, the other elements need not be located at the same physical site. For example, portions of the file storage system can be coupled via various local-area or wide-area network links, including telephone lines. Similarly, the input devices and display need not be located at the same site as the processor, although it is anticipated that the present invention will likely be implemented in the context of general-purpose computers and workstations.

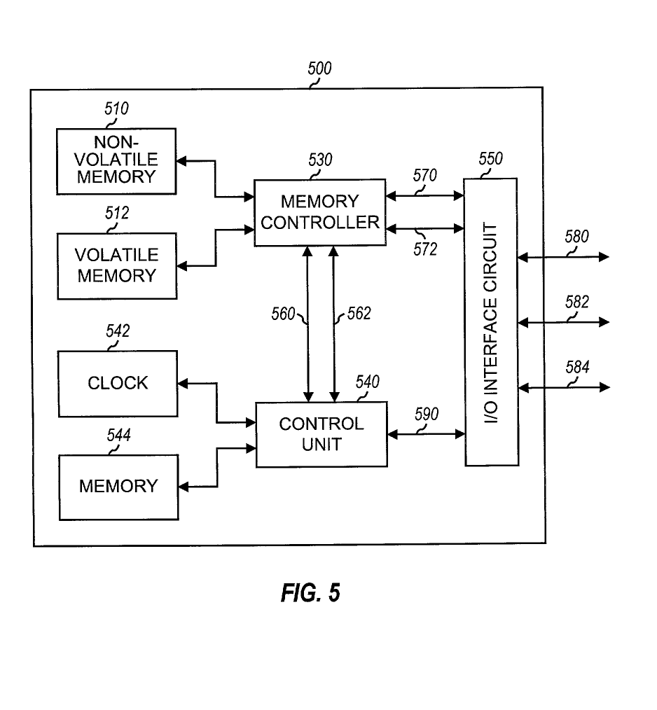

FIG. 5 shows a simplified block diagram of an embodiment of a SMD 500 that can implement the SMDs in FIGS. 1 through 3. Within SMD 500, a non-volatile memory 510 and a volatile memory 512 receive data from, and provide data to, a memory controller 530. Memories 510 and 512 provide storage of accounting data, program codes, and other data. In an embodiment, some of the accounting data is stored in an ascending register, a descending register, and a control total register (none of which is shown in FIG. 5). The ascending register holds a value indicative of the amount of postage used, the descending register holds a value indicative of the amount of postage that remains unused (i.e., the available funds), and the control total register holds the sum of the values in the ascending and descending registers.

Memory controller 530 may be accessed by a control unit 540 and an input/output (I/O) interface circuit 550. Control unit 540 accesses memories 510 and 512 by reading or writing on data lines 560, and controls these operations via control lines 562. I/O interface circuit 550 accesses memories 510 and 512 by reading or writing data on data lines 570, and controls these operations via control lines 572.

As shown in FIG. 5, I/O interface circuit 550 further couples to a service port 580, an I/O port 582, and an (optional) printer port 584. Service port 580 allows access (e.g., with proper access codes) to memories 510 and 512 (e.g., for diagnostic, repair, and maintenance of SMD 500). I/0 port 582 supports communications with a general-purpose computer such as central computer 122 in FIG. 1. Printer port 584 supports communications with a printer to allow printing of postage indicia directly from SMD 500.

Control unit 540 communicates with service port 580, I/O port 582, and printer port 584 via control and data lines 590 and I/O interface circuit 550. Control unit 540 includes circuitry for controlling the functions of SMD 500, and may couple to a clock 542, a memory 544, and other circuitry (not shown in FIG. 5) that supports the operation of control unit 540. Memory 544 may comprise volatile and/or non-volatile memories.

The secure processing (e.g., encryption, encoding, digital signature generation, and other functions) may be performed by a sub-unit of control unit 540, such as a hardware security processor (not shown). Alternatively, the secure processing may be performed by a software algorithm resident in memory 544 and executed by control unit 540. The secure processing may implement, for example, the DES and RSA algorithms for encryption, the DSA and elliptical curve algorithms for digital signature generation, and other algorithms. Encryption/decryption and digital signature generation/authentication are further described in detail in a book by William Stallings, entitled “Cryptography and Network Security: Principles and Practice, 2^{nd} Edition,” Prentice-Hall, Inc., 1999.

In an embodiment, communication between the central computer and the SMD is bi-directional. The central computer sends control commands, data requests, requests for postage indicia, and the like to the SMD. In response, the SMD may send human-readable data (i.e., in response to a request for data), encrypted data (e.g., representative of a postage indicium), and other data in various formats, or a combination thereof. In an embodiment, the SMD communicates with the central computer in similar manner as that described in the aforementioned U.S. patent application Ser. No. 09/250,990.

The SMD architecture shown in FIG. 5 resembles, to an extent, the architecture disclosed in U.S. Pat. No. 4,484,307 issued Quatse et al. and incorporated herein by reference. Another SMD architecture is disclosed in the aforementioned U.S. patent application Ser. No. 09/250,990. Other SMD architectures can be designed and are within the scope of the invention.

Processor 410 and control unit 540 can each be implemented as an application specific integrated circuit (ASIC), a digital signal processor, a controller, a microcontroller, a microprocessor, or other electronic units designed to perform the functions described herein. Non-volatile memories 436 and 510 can each be implemented as a read only memory (ROM), a FLASH memory, a programmable ROM (PROM), an erasable PROM (EPROM), an electronically erasable PROM (EEPROM), a battery augmented memory (BAM), a battery backed-up RAM (BBRAM), or devices of other memory technologies. Volatile memory 438 and 512 can each be implemented as a random access memory (RAM), a dynamic RAM (DRAM), a FLASH memory, or devices of other memory technologies.

Software codes to execute various aspects of the invention are located throughout the postal system (i.e., within the SMDs and the remote and central computers). For example, in FIG. 1, software codes resident on remote computer 140 enable communication with central computer 122, SMD 126, wireless communications device 160, printer 170, and (optional) electronic scale 180. Similarly, software codes resident on central computer 122 enable communication with remote computer 140 and SMD 126. Software codes resident on SMD 126 enable communication with the central and remote computers. An example of a protocol that supports communication between the central and remote computers and the SMD is disclosed in the aforementioned U.S. patent application Ser. No. 09/250,990. Software codes for performing the postage accounting functions of SMD 126 can be implemented similar to that disclosed in the aforementioned U.S. Pat. No. 4,484,307 and U.S. patent application Ser. No. 09/250,990.

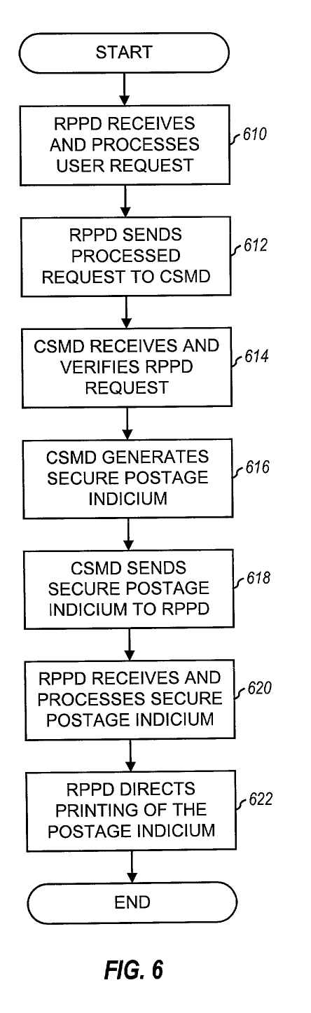

FIG. 6 shows a flow diagram of an embodiment of a process for generating and remotely printing postage indicia in accordance with the invention. The process begins at step 610, where the RPPD receives a user request for postage. In conjunction with the request, the RPPD may also receive other pertinent postal information from the user. The RPPD then processes the user request, also at step 610. In a specific embodiment, the RPPD processing of the user request includes generating a digital signature that allows the CSMD to authenticate the request. The processing can further include encrypting or encoding the request so as to deter the generation of fraudulent requests. The RPPD then sends the processed request along with other postal information to the CSMD, at step 612. The postal information can include, for example, the mail class/service, the destination ZIP-code, other required values such as insurance, and so on. Any failure in this communication from the RPPD prevents issuance of postage by the CSMD.

In a specific embodiment, each RPPD is designated with an identifier that uniquely identifies that particular RPPD. The identifier can be used to prevent the fraudulent receipt of postage value, to allow for easy identification of a suspect RPPD, to maintain organization in the system, and to implement other functions.

At step 614, the CSMD receives and verifies the RPPD request. If the request includes a digital signature, the CSMD authenticates the signature using techniques known in the art. Digital signature generation and authentication is described in the aforementioned book entitled “Cryptography and Network Security: Principles and Practice, 2^{nd} Edition.”

In an embodiment, once the request is authenticated, the CSMD generates a secure postage indicium, at step 616. The secure postage indicium can be generated using, for example, encryption, encoding, digital signature, or a combination thereof. The secure postage indicium may include, for example, the requested postage value, the identifier of the RPPD requesting the indicium, and a “unique identifier” generated for each transaction. In a specific embodiment, the secure postage indicium is represented by a file containing digital data.

In an embodiment, the funds required for the requested postage are accounted for (i.e., debited) by the CSMD as part of the processing of the request. In a specific implementation, after the user request is validated, the CSMD requests a transfer of funds from the user's bank account to the postal service's receiving account. In this implementation, upon a successful transfer of funds, the CSMD issues a one-time identifier that indicates the validity of the generated indicium.

The secure postage indicium is then sent from the CSMD to the RPPD, at step 618. In an embodiment, the requested RPPD responds to the CSMD transmission based on the unique identifier included with each transmitted indicium from the CSMD. The requested RPPD receives and processes the secure postage indicium, at step 620. In an embodiment, as part of the RPPD processing, some of the information encoded by the CSMD may be decoded by the RPPD in order to verify that the source of the postage indicium is authentic. In an embodiment, the RPPD constructs a postage indicia print file that may include, for example, a two-dimensional code, graphical information, and human-readable data.

The RPPD then sends the postage indicia print file along with other optional data to the printer for printing. Such optional data can include, for example, address information, ZIP-code barcoding, and other user-defined information. Finally, the printer imprints the postage indicium and other information onto an envelope, a label, or other means of affixation of postage, at step 622.

Many variations on the processing described above can be envisioned by one of skill in the art and are within the scope of the invention. For example, a simple process can be implemented in which only the indicium contains encoded information. Additional safeguards can be applied to prevent fraudulent printing of postage value (e.g., a complex validation hand-shaking protocol, and the like).

With the invention, the process of sending postage value can be achieved within seconds (i.e., in real-time), allowing for essentially continuous processing of mail by the user. The central computer is in communication with each SMD attached thereto. Once a request is validated by the user, the remainder of the transactions can be carried out by the CSMD and RPPD without further human intervention.

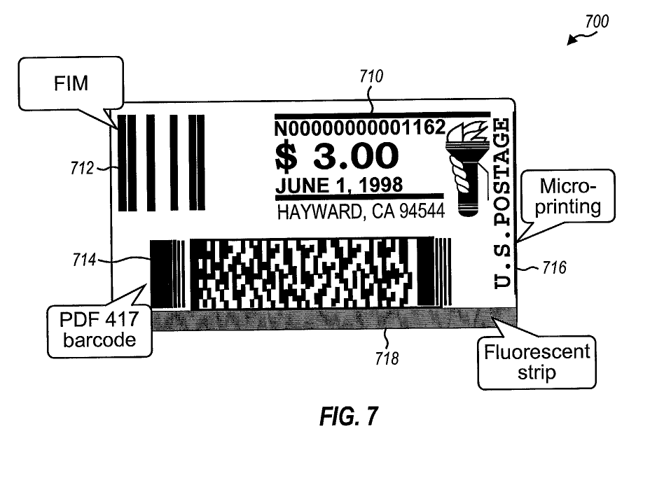

FIG. 7 shows an illustration of a specific embodiment of an indicium 700 generated and remotely printed in accordance with the invention. In an embodiment, indicium 700 is printed on a preprinted postage label and includes a human-readable portion 710, a facing identification mark (FIM) marking 712, and a barcode 714. As shown in FIG. 7, human-readable portion 710 includes a device ID number, the postage amount, the date the indicium was printed, the origination address (e.g., the city, state, and zip code), and a rate category. The destination address (e.g., the destination zip code) can also be printed in the human-readable portion of indicium 700, although this is not shown in FIG. 7. The FIM marking and the (e.g., PDF 417) barcode typically conform to IBIP specifications and are used to assist the postal authority in the detection of fraud. In the specific embodiment shown in FIG. 7, indicium 700 further includes a micro printing portion 716 and a fluorescent identifier (e.g., a stripe) 718 that discourage counterfeits and assist in the their detection.

FIG. 7 shows a specific embodiment of an indicium. The indicium can be designed to include additional, fewer, or different elements than that shown in FIG. 7. The elements of indicium 700 and its generation are further described in the aforementioned U.S. patent application Ser. No. 09/250,990 and (Attorney Docket No. 6969-160.1).

The postal system of the invention includes many features and provides many advantages. Some of these advantages are enumerated below.

First, the invention maintains accounting information and postage value at a higher level of security than for conventional postage metering systems. The accounting information stored in the CSMD's registers and memory remains in a secure and centralized location. Only the RPPDs are located in the field. This is an improvement over conventional postage meters that can hold very large sums of funds (e.g., $99,999.99) and must be carefully controlled by the user to prevent loss due to misappropriation of postage, malicious misuse, or errors by inexperienced operators. If the conventional meter is misused, or is stolen and not recovered, the amount of funds held in the meter can be irrecoverably lost to the user.

Second, the invention protects the user's funds by secure processing of data transferred into and out of the SMD. The secure processing can be achieved with the use of digital signatures, encryption, encoding, or a combination thereof. The secure processing ensures that the software or hardware cannot be easily tampered or modified to alter the accounting information.

Third, the invention allows for substantial flexibility in use because of the RPPD's simplicity and portability. As noted above, the RPPD can be designed as a stationary, portable, or hand-held unit, and can be located anywhere wireless communication can be maintained with the CSMD. For example, in a warehouse it may be advantageous to move the RPPD around and place postage on parcels instead of moving the parcels past a metering station. In a business, the RPPD can be taken to locations where mail is prepared, reducing processing activity in the mailroom. Postage may be provided to individual sites of a multi-site user.

Fourth, the invention provides a RPPD that can be designed as a low-cost unit using simplified processor, printing mechanism, and wireless communication device. In this case, if the RPPD is lost or stolen, it can be deactivated, thereby limiting the loss to the cost of the RPPD, and not to the cost of postage normally contained in a postage metering device. The software and hardware required to implement the RPPD can be (relatively) inexpensive in comparison to the costs of conventional postage metering systems. This allows the RPPD to be dedicated to individual user or a small group of users.

Fifth, the invention allows for consolidation of postage accounting information. Multi-site users can benefit from a simplified and more efficient tracking of such information. Because of the CSMD's central location in the system, it can be configured to automatically consolidate postage accounting data relevant to the sites it serves. Such data may also be separated so as to report on individual sites. The invention can thus make site-specific postage accounting information available to the user's central accounting facility as well as the site accounting facility.

The invention allows individual sites of a multi-site user to process mail continuously, with payment to the post office and replenishment of funds handled through the central accounting facilities provided by the CSMD. For example, as long as the user's central accounting facility maintains adequate fund reserves, the individual RPPDs can have access to a service that provides postage on an as-needed basis. The need for individual cash accounts to prepay on-site postage meters is thus eliminated.

Sixth, the invention provides a RPPD that is simple to use in comparison to conventional postage meters. The individual user or site need not maintain logbooks, lease equipment, comply with special regulations, physically transport a postage metering device to a post office for inspection, nor perform other custodial tasks normally related to the use of conventional postage meters.

The foregoing description of the specific embodiments is provided to enable any person skilled in the art to make or use the present invention. Various modifications to these embodiments will be readily apparent to those skilled in the art, and the generic principles defined herein may be applied to other embodiments without the use of the inventive faculty. For example, digital signatures, encryption (e.g., DES, RSA, and others), and other coding techniques can be incorporated with the present invention. Thus, the present invention is not intended to be limited to the embodiments shown herein but is to be accorded the widest scope consistent with the principles and novel features disclosed herein.

What is claimed is:

1. A postage metering system comprising:
a central processing system that includes
a central computer, and
a secure metering device (SMD) operatively coupled to the central computer and configured to store accounting information; and
a remote postage printing device (RPPD) operatively coupled to the SMD via a wireless communications link, the RPPD configured to
receive a user request for postage,
transmit the user request to the SMD via the wireless communications link,
receive a secure postage indicium from the SMD, and
direct printing of an indicium.

2. The system of claim 1, further comprising:
a printer coupled to the RPPD and configured to print the indicium when directed.

3. The system of claim 1, wherein the central processing system further includes a first wireless communications device coupled to the central computer, and wherein the RPPD includes a second wireless communications device.

4. The system of claim 3, wherein the first and second wireless communications devices are operated at an RF frequency.

5. The system of claim 1 wherein the SMD includes
revenue registers configured to store the accounting information,
a processor configured to receive the accounting information, direct generation of the secure postage indicium having a value, and account for the indicium value, and
an enclosure that houses the processor and the revenue registers.

6. The system of claim 1 wherein the SMD is enclosed within the central computer.

7. The system of claim 1, wherein the RPPD includes
a processor,
a print unit coupled to the processor,
a wireless communications device coupled to the processor, and
a housing that encloses the processor, printing unit, and communications device.

8. The system of claim 7, wherein the RPPD is housed in a portable housing.

9. The system of claim 1, wherein the RPPD is configured as a hand-held unit.

10. The system of claim 1, wherein the SMD is further configured to authenticate and process the user request from the RPPD.

11. The system of claim 1, wherein the secure postage indicium includes a digital signature.

12. The system of claim 1, wherein the secure postage indicium is generated using encryption.

13. The system of claim 1, wherein the secure postage indicium includes an identifier indicative of accounted for payment of the indicium.

14. The system of claim 1, wherein the secure postage indicium is represented by a file containing digital data.

15. The system of claim 1, wherein the RPPD is identified by a unique identifier.

16. The system of claim 1, wherein the SMD communicates with the central computer via a secure communications link.

17. The system of claim 1, wherein the RPPD transmits the user request along with a digital signature to the SMD.

18. A postage metering system comprising:
a central processing system that includes
a central computer;
at least one secure metering device (SMD) operatively coupled to the central computer, each SMD configured to store postal accounting information for a particular set of users; and
a plurality of remote postage printing devices (RPPDs) operatively coupled to the at least one SMD via a wireless communications link, each RPPD configured to
receive a user request for postage,
transmit the user request to a particular SMD via the wireless communications link,
receive a secure postage indicium from the particular SMD, and
direct printing of the requested indicium.

19. The system of claim 1, wherein each SMD is configured to process user requests from a particular set of RPPDs.

20. A method for remotely printing postage comprising:
receiving a user request for postage at a remote postage printing device (RPPD);
sending the user request from the RPPD to a central secure metering device (CSMD) via a wireless communications link;
receiving a secure postage indicium from the CSMD;
verifying an authenticity of the secure postage indicium; and
directing printing of a postage indicium in accordance with the verified secure postage indicium.

21. The method of claim 20, further comprising:
authenticating the user request from the RPPD.

22. The method of claim 21, further comprising
generating the secure postage indicium in response to the authenticated user request.

23. The method of claim 22, wherein the secure postage indicium is generated using digital signature.

24. The method of claim 22, wherein the secure postage indicium is generated using encryption.
